(19) United States
(12) Patent Application Publication
(10) Pub. No.: US 2020/0021478 A1
(43) Pub. Date: Jan. 16, 2020

(54) PREDISTORTION METHOD, APPARATUS, AND SYSTEM

(71) Applicant: HUAWEI TECHNOLOGIES CO., LTD., Shenzhen (CN)

(72) Inventors: Xiaoshu SI, Wuhan (CN); Linnik MIKHAIL, Moscow (RU); Fanping DU, Dongguan (CN)

(73) Assignee: HUAWEI TECHNOLOGIES CO., LTD., Shenzhen (CN)

(21) Appl. No.: 16/582,954

(22) Filed: Sep. 25, 2019

Related U.S. Application Data
(63) Continuation of application No. PCT/CN2017/079197, filed on Apr. 1, 2017.

(51) Int. Cl. H04L 27/36; H04B 1/04

(52) U.S. Cl. CPC H04L 27/367; H04B 2001/0425; H04B 1/0475

(57) ABSTRACT

A predistortion method and apparatus, wherein the predistortion method includes: sending a first sequence, and storing the sent first sequence; receiving a second sequence that is fed back, where the second sequence is a sequence obtained after sampling is performed on the first sequence that suffers distortion; obtaining a third sequence after performing sampling on the stored first sequence, where a sampling rate for obtaining the third sequence through sampling is the same as a sampling rate for obtaining the second sequence through sampling; and determining, based on the second sequence and the third sequence, a linear distortion coefficient corresponding to each of at least one Nyquist interval in a spectrum for sending a signal, where the linear distortion coefficient is used to perform linear compensation on the sent signal.

### CROSS-REFERENCE TO RELATED APPLICATIONS

This application is a continuation of International Application No. PCT/CN2017/079197, filed on Apr. 1, 2017, the disclosure of which is hereby incorporated by reference in its entirety.

### TECHNICAL FIELD

Embodiments of this application relate to the communications field, and more specifically, to a predistortion method, apparatus, and system.

### BACKGROUND

The communications industry is always considered as one of the pillar industries of national production. Various communication-related products are closely related to people's production and way of life. In a (wireless or wired) communications system, a transmitter is one of most important components, and is configured to: modulate and up-convert a baseband signal, and finally amplify the baseband signal and then transmit it. A power amplifier is a most important component in the transmitter, and performance of the power amplifier directly affects performance of the transmitter and even affects performance of an entire base station.

A power amplifier linearization technology has developed since the 1920s, and has developed from initial radio frequency and analog linearization to current baseband and digital linearization. An early linearization technology is usually used to reduce nonlinearity by improving a radio frequency circuit from a perspective of a physical characteristic of a power amplifier. However, reliability of the radio frequency circuit is poor. Therefore, linearity of the power amplifier is not greatly improved by using this method. In addition, memory of the power amplifier in a broadband case cannot be effectively compensated for by using this method. In the 1980s, a digital predistortion (Digital Pre-Distortion, DPD) technology was proposed to facilitate great development of linearization technologies. Among all linearization technologies, digital predistortion costs were the lowest.

A principle of compensating for nonlinear distortion by using a down-sampling DPD technology is as follows: A digital-to-analog converter (Digital to Analog Converter, DAC) in a transmit end outputs an analog baseband signal, the analog baseband signal is up-converted to output a radio frequency signal, and then the radio frequency signal is processed by a power amplifier. A feedback link signal is first down-converted to output an analog baseband signal, a down-sampling analog-to-digital converter (Analog to Digital Converter, ADC) performs signal sampling, and then a DPD coefficient is calculated based on a collected signal and a sent reference signal. Because analog frequency conversion is used, a process in which the ADC performs sampling occurs on a low frequency band. In addition, a signal bandwidth is narrow. Therefore, the signal collected by the down-sampling ADC suffers very small linear distortion, and this has little impact on subsequent nonlinear distortion estimation.

A full-digital frequency conversion technology tends to be used in a current communications system such as the data over cable service interface specification (Data Over Cable Service Interface Specification, DOCSIS), to reduce use of an analog component and improve system performance and stability. In this type of system, a process in which an ADC performs sampling occurs on a high frequency band, a signal bandwidth is very wide. As a result, a signal collected by the down-sampling ADC suffers relatively serious linear distortion, and this has a great impact on subsequent nonlinear distortion estimation. Therefore, linear distortion needs to be first estimated before the predistortion technology is used.

The prior art is based on analog frequency conversion and a very narrow signal bandwidth, and linear distortion is relatively small. Therefore, estimation may be performed by directly using a least square (Least Square, LS) method. However, in a full-digital frequency conversion and broadband system, if linear distortion is estimated by directly using the LS method, linear distortion cannot be effectively estimated, and this has a great impact on subsequent nonlinear distortion estimation.

### SUMMARY

Embodiments of this application provide a predistortion method, apparatus, and system, so that linear distortion can be effectively estimated and compensated for, to help avoid affecting subsequent nonlinear distortion estimation and compensation.

According to a first aspect, a predistortion method is provided, where the method includes: sending a first sequence, and storing the sent first sequence; receiving a second sequence that is fed back, where the second sequence is a sequence obtained after sampling is performed on the first sequence that suffers distortion; obtaining a third sequence after performing sampling on the stored first sequence, where a sampling rate for obtaining the third sequence through sampling is the same as a sampling rate for obtaining the second sequence through sampling; and determining, based on the second sequence and the third sequence, a linear distortion coefficient corresponding to each of at least one Nyquist interval in a spectrum for sending a signal, where the linear distortion coefficient is used to perform linear compensation on the sent signal.

With reference to the first aspect, in a first possible implementation of the first aspect, the first sequence includes a first data sequence and a first preamble sequence set, a spectrum of one preamble sequence in the first preamble sequence set corresponds to one Nyquist interval, and the second sequence includes a second data sequence corresponding to the first data sequence and a received sequence set corresponding to the first preamble sequence set; the obtaining a third sequence after performing sampling on the stored first sequence includes: obtaining a second preamble sequence set of the third sequence after performing sampling on the first preamble sequence set of the first sequence, where a sampling rate for obtaining the second preamble sequence set through sampling is the same as a sampling rate for obtaining the received sequence set through sampling; and the determining, based on the second sequence and the third sequence, a linear distortion coefficient corresponding to each of at least one Nyquist interval in a spectrum for sending a signal includes: determining, based on the received sequence set and the second preamble sequence set, the linear distortion coefficient corresponding to each of the at least one Nyquist interval in the spectrum for sending a signal.

In some possible implementations, the determining, based on the received sequence set and the second preamble sequence set, the linear distortion coefficient corresponding to each of the at least one Nyquist interval in the spectrum for sending a signal includes: determining, by using a least square method based on the received sequence set and the second preamble sequence set, the linear distortion coefficient corresponding to each of the at least one Nyquist interval in the spectrum for sending a signal.

According to the predistortion method in this embodiment of this application, due to a design of preamble sequences, the linear distortion coefficient corresponding to each Nyquist interval in the spectrum for sending a signal can be accurately estimated, so that linear compensation is effectively performed on data in each Nyquist interval in the spectrum for sending a signal.

With reference to the first aspect, in a second possible implementation of the first aspect, the first sequence includes a first data sequence, and the second sequence includes a second data sequence corresponding to the first data sequence; the obtaining a third sequence after performing sampling on the stored first sequence includes: extracting data in each of the at least one Nyquist interval from the first data sequence; and obtaining a reference sequence set after performing sampling on the data in each of the at least one Nyquist interval, where a sampling rate for obtaining the reference sequence set through sampling is the same as a sampling rate for obtaining the second data sequence through sampling; and the determining, based on the second sequence and the third sequence, a linear distortion coefficient corresponding to each of at least one Nyquist interval in a spectrum for sending a signal includes: determining, based on the second data sequence and the reference sequence set, the linear distortion coefficient corresponding to each of the at least one Nyquist interval in the spectrum for sending a signal.

In some possible implementations, the determining, based on the reference sequence set and the second data sequence, the linear distortion coefficient corresponding to each of the at least one Nyquist interval in the spectrum for sending a signal includes: determining, by using a least square method based on the reference sequence set and the second data sequence, the linear distortion coefficient corresponding to each of the at least one Nyquist interval in the spectrum for sending a signal.

According to the predistortion method in this embodiment of this application, the linear distortion coefficient corresponding to each Nyquist interval in the spectrum for sending a signal can be estimated, so that linear compensation can be performed on the data in each Nyquist interval in the spectrum for sending a signal.

With reference to the second possible implementation of the first aspect, in a third possible implementation of the first aspect, that the linear distortion coefficient is used to perform linear compensation on the sent signal includes: performing linear compensation on the reference sequence set.

With reference to the first possible implementation of the first aspect, in a fourth possible implementation of the first aspect, the method further includes: extracting data in each of the at least one Nyquist interval from the first data sequence; and obtaining a reference sequence set after performing sampling on the data in each of the at least one Nyquist interval, where a sampling rate for obtaining the reference sequence set through sampling is the same as a sampling rate for obtaining the second data sequence through sampling, where that the linear distortion coefficient is used to perform linear compensation on the sent signal includes: performing linear compensation on the reference sequence set.

With reference to any one of the second to the fourth possible implementations of the first aspect, in a fifth possible implementation of the first aspect, the method further includes: determining a first reference data set based on the reference sequence set and the linear distortion coefficient that is corresponding to each of the at least one Nyquist interval, where the first reference data set is used to determine a nonlinear distortion coefficient of the sent signal.

In some possible implementations, the determining a first reference data set based on the reference sequence set and the linear distortion coefficient that is corresponding to each of the at least one Nyquist interval includes: obtaining the first reference data set by performing convolution on the reference sequence set and the linear distortion coefficient that is corresponding to each of the at least one Nyquist interval.

With reference to the fifth possible implementation of the first aspect, in a sixth possible implementation of the first aspect, the method further includes: determining the nonlinear distortion coefficient of the sent signal based on the first reference data set and the second data sequence; and performing nonlinear compensation on the sent signal based on the nonlinear distortion coefficient.

With reference to the sixth possible implementation of the first aspect, in a seventh possible implementation of the first aspect, the determining the nonlinear distortion coefficient of the sent signal based on the first reference data set and the second data sequence includes: adding all reference data in the first reference data set, to obtain second reference data; and determining the nonlinear distortion coefficient of the sent signal based on the second reference data and the second data sequence.

According to the predistortion method in this embodiment of this application, linear distortion of each of the at least one Nyquist interval in the spectrum for sending a signal can be effectively estimated and compensated for, so that nonlinear distortion of the sent signal can be effectively estimated and compensated for.

According to a second aspect, a predistortion apparatus is provided, where the apparatus includes: a transceiver, configured to: send a first sequence, and store the sent first sequence, where the transceiver is further configured to receive a second sequence that is fed back, where the second sequence is a sequence obtained after sampling is performed on the first sequence that suffers distortion; and a processor, configured to obtain a third sequence after performing sampling on the stored first sequence, where a sampling rate for obtaining the third sequence through sampling is the same as a sampling rate for obtaining the second sequence through sampling, where the processor is further configured to determine, based on the second sequence and the third sequence, a linear distortion coefficient corresponding to each of at least one Nyquist interval in a spectrum for sending a signal, where the linear distortion coefficient is used to perform linear compensation on the sent signal.

With reference to the second aspect, in a first possible implementation of the second aspect, the first sequence includes a first data sequence and a first preamble sequence set, a spectrum of one preamble sequence in the first preamble sequence set corresponds to one Nyquist interval, and the second sequence includes a second data sequence corresponding to the first data sequence and a received sequence set corresponding to the first preamble sequence set; the processor is specifically configured to obtain a second preamble sequence set of the third sequence after performing sampling on the first preamble sequence set of the first sequence, where a sampling rate for obtaining the second preamble sequence set through sampling is the same as a sampling rate for obtaining the received sequence set through sampling; and the processor is further configured to determine, based on the received sequence set and the second preamble sequence set, the linear distortion coefficient corresponding to each of the at least one Nyquist interval in the spectrum for sending a signal.

In some possible implementations, the processor is specifically configured to determine, by using a least square method based on the received sequence set and the second preamble sequence set, the linear distortion coefficient corresponding to each of the at least one Nyquist interval in the spectrum for sending a signal.

According to the predistortion apparatus in this embodiment of this application, due to design of preamble sequences, the linear distortion coefficient corresponding to each Nyquist interval in the spectrum for sending a signal can be accurately estimated, so that linear compensation is effectively performed on data in each Nyquist interval in the spectrum for sending a signal.

With reference to the second aspect, in a second possible implementation of the second aspect, the first sequence includes a first data sequence, and the second sequence includes a second data sequence corresponding to the first data sequence; the processor is specifically configured to: extract data in each of the at least one Nyquist interval from the first data sequence; and obtain a reference sequence set after performing sampling on the data in each of the at least one Nyquist interval, where a sampling rate for obtaining the reference sequence set through sampling is the same as a sampling rate for obtaining the second data sequence through sampling; and the processor is further configured to determine, based on the second data sequence and the reference sequence set, the linear distortion coefficient corresponding to each of the at least one Nyquist interval in the spectrum for sending a signal.

In some possible implementations, the processor is specifically configured to determine, by using a least square method based on the second data sequence and the reference sequence set, the linear distortion coefficient corresponding to each of the at least one Nyquist interval in the spectrum for sending a signal.

According to the predistortion apparatus in this embodiment of this application, the linear distortion coefficient corresponding to each Nyquist interval in the spectrum for sending a signal can be estimated, so that linear compensation can be performed on the data in each Nyquist interval in the spectrum for sending a signal.

With reference to the second possible implementation of the second aspect, in a third possible implementation of the second aspect, the processor is specifically configured to perform linear compensation on the reference sequence set.

With reference to the first possible implementation of the second aspect, in a fourth possible implementation of the second aspect, the processor is further configured to: extract data in each of the at least one Nyquist interval from the first data sequence; and obtain a reference sequence set by performing linear compensation on the data in each of the at least one Nyquist interval, where a sampling rate for obtaining the reference sequence set through sampling is the same as a sampling rate for obtaining the second data sequence through sampling; and the processor is specifically configured to perform linear compensation on the reference sequence set.

With reference to any one of the second to the fourth possible implementations of the second aspect, in a fifth possible implementation of the second aspect, the processor is further configured to determine a first reference data set based on the reference sequence set and the linear distortion coefficient that is corresponding to each of the at least one Nyquist interval, where the first reference data set is used to determine a nonlinear distortion coefficient of the sent signal.

In some possible implementations, the processor is specifically configured to perform convolution on the reference sequence set and the linear distortion coefficient that is corresponding to each of the at least one Nyquist interval, to obtain the first reference data set.

With reference to the fifth possible implementation of the second aspect, in a sixth possible implementation of the second aspect, the processor is further configured to determine the nonlinear distortion coefficient of the sent signal based on the first reference data set and the second data sequence; and the processor is further configured to perform nonlinear compensation on the sent signal based on the nonlinear distortion coefficient.

With reference to the sixth possible implementation of the second aspect, in a seventh possible implementation of the second aspect, the processor is specifically configured to: add all reference data in the first reference data set, to obtain second reference data; and determine the nonlinear distortion coefficient of the sent signal based on the second reference data and the second data sequence.

According to the predistortion apparatus in this embodiment of this application, linear distortion of each of the at least one Nyquist interval in the spectrum for sending a signal can be effectively estimated and compensated for, so that nonlinear distortion of the sent signal can be effectively estimated and compensated for.

According to a third aspect, a predistortion apparatus is provided, where the apparatus includes: a transceiver module, configured to: send a first sequence, and store the sent first sequence, where the transceiver module is further configured to receive a second sequence that is fed back, where the second sequence is a sequence obtained after sampling is performed on the first sequence that suffers distortion; and a processing module, configured to obtain a third sequence after performing sampling on the stored first sequence, where a sampling rate for obtaining the third sequence through sampling is the same as a sampling rate for obtaining the second sequence through sampling, where the processing module is further configured to determine, based on the second sequence and the third sequence, a linear distortion coefficient corresponding to each of at least one Nyquist interval in a spectrum for sending a signal, where the linear distortion coefficient is used to perform linear compensation on the sent signal.

With reference to the third aspect, in a first possible implementation of the third aspect, the first sequence includes a first data sequence and a first preamble sequence set, a spectrum of one preamble sequence in the first preamble sequence set corresponds to one Nyquist interval, and the second sequence includes a second data sequence corresponding to the first data sequence and a received sequence set corresponding to the first preamble sequence set; the processing module is specifically configured to obtain a second preamble sequence set of the third sequence after performing sampling on the first preamble sequence set of the first sequence, where a sampling rate for obtaining the second preamble sequence set through sampling is the same as a sampling rate for obtaining the received sequence set through sampling; and the processing module is further configured to determine, based on the received sequence set and the second preamble sequence set, the linear distortion coefficient corresponding to each of the at least one Nyquist interval in the spectrum for sending a signal.

In some possible implementations, the processing module is specifically configured to determine, by using a least square method based on the received sequence set and the second preamble sequence set, the linear distortion coefficient corresponding to each of the at least one Nyquist interval in the spectrum for sending a signal.

According to the predistortion apparatus in this embodiment of this application, due to design of preamble sequences, the linear distortion coefficient corresponding to each Nyquist interval in the spectrum for sending a signal can be accurately estimated, so that linear compensation is effectively performed on data in each Nyquist interval in the spectrum for sending a signal.

With reference to the third aspect, in a second possible implementation of the third aspect, the first sequence includes a first data sequence, and the second sequence includes a second data sequence corresponding to the first data sequence; the processing module is specifically configured to: extract data in each of the at least one Nyquist interval from the first data sequence; and obtain a reference sequence set after performing sampling on the data in each of the at least one Nyquist interval, where a sampling rate for obtaining the reference sequence set through sampling is the same as a sampling rate for obtaining the second data sequence through sampling; and the processing module is further configured to determine, based on the second data sequence and the reference sequence set, the linear distortion coefficient corresponding to each of the at least one Nyquist interval in the spectrum for sending a signal.

In some possible implementations, the processing module is specifically configured to determine, by using a least square method based on the second data sequence and the reference sequence set, the linear distortion coefficient corresponding to each of the at least one Nyquist interval in the spectrum for sending a signal.

According to the predistortion apparatus in this embodiment of this application, the linear distortion coefficient corresponding to each Nyquist interval in the spectrum for sending a signal can be estimated, so that linear compensation can be performed on the data in each Nyquist interval in the spectrum for sending a signal.

With reference to the second possible implementation of the third aspect, in a third possible implementation of the third aspect, the processing module is specifically configured to perform linear compensation on the reference sequence set.

With reference to the first possible implementation of the third aspect, in a fourth possible implementation of the third aspect, the processing module is further configured to: extract data in each of the at least one Nyquist interval from the first data sequence; and obtain a reference sequence set after performing sampling on the data in each of the at least one Nyquist interval, where a sampling rate for obtaining the reference sequence set through sampling is the same as a sampling rate for obtaining the second data sequence through sampling; and the processing module is specifically configured to perform linear compensation on the reference sequence set.

With reference to any one of the second to the fourth possible implementations of the third aspect, in a fifth possible implementation of the third aspect, the processing module is further configured to determine a first reference data set based on the reference sequence set and the linear distortion coefficient that is corresponding to each of the at least one Nyquist interval, where the first reference data set is used to determine a nonlinear distortion coefficient of the sent signal.

In some possible implementations, the processing module is specifically configured to perform convolution on the reference sequence set and the linear distortion coefficient that is corresponding to each of the at least one Nyquist interval, to obtain the first reference data set.

With reference to the fifth possible implementation of the third aspect, in a sixth possible implementation of the third aspect, the processing module is further configured to determine the nonlinear distortion coefficient of the sent signal based on the first reference data set and the second data sequence; and the processing module is further configured to perform nonlinear compensation on the sent signal based on the nonlinear distortion coefficient.

With reference to the sixth possible implementation of the third aspect, in a seventh possible implementation of the third aspect, the processing module is specifically configured to: add all reference data in the first reference data set, to obtain second reference data; and determine the nonlinear distortion coefficient of the sent signal based on the second reference data and the second data sequence.

According to the predistortion apparatus in this embodiment of this application, linear distortion of each of the at least one Nyquist interval in the spectrum for sending a signal can be effectively estimated and compensated for, so that nonlinear distortion of the sent signal can be effectively estimated and compensated for.

According to a fourth aspect, a predistortion system is provided, where the predistortion system includes a transmit end and a receive end, and the transmit end includes the apparatus according to any one of the second aspect or the possible implementations of the second aspect, or the transmit end includes the apparatus according to any one of the third aspect or the possible implementations of the third aspect.

According to a fifth aspect, a computer readable storage medium is provided, where the computer readable storage medium stores an instruction, and when the instruction runs on a computer, the computer performs the method according to the foregoing aspects.

### DESCRIPTION OF DRAWINGS

FIG. 1 is a schematic diagram of an application scenario of a technical solution according to an embodiment of this application;

FIG. 2 is a schematic flowchart of a predistortion method according to an embodiment of this application;

FIG. 3 is a schematic block diagram of a data structure of a sent signal and a data structure of a received signal according to an embodiment of this application;

FIG. 4 is another schematic block diagram of a data structure of a sent signal and a data structure of a received signal according to an embodiment of this application;

FIG. 5 is an algorithm flowchart of a predistortion method according to an embodiment of this application;

FIG. 6 is another algorithm flowchart of a predistortion method according to an embodiment of this application;

FIG. 7 is a schematic block diagram of a predistortion apparatus according to an embodiment of this application;

FIG. 8 is another schematic block diagram of a predistortion apparatus according to an embodiment of this application;

FIG. 9 is a schematic block diagram of a predistortion system according to an embodiment of this application; and

FIG. 10 is another schematic block diagram of a predistortion system according to an embodiment of this application.

### DESCRIPTION OF EMBODIMENTS

The following describes the technical solutions in the embodiments of this application with reference to the accompanying drawings.

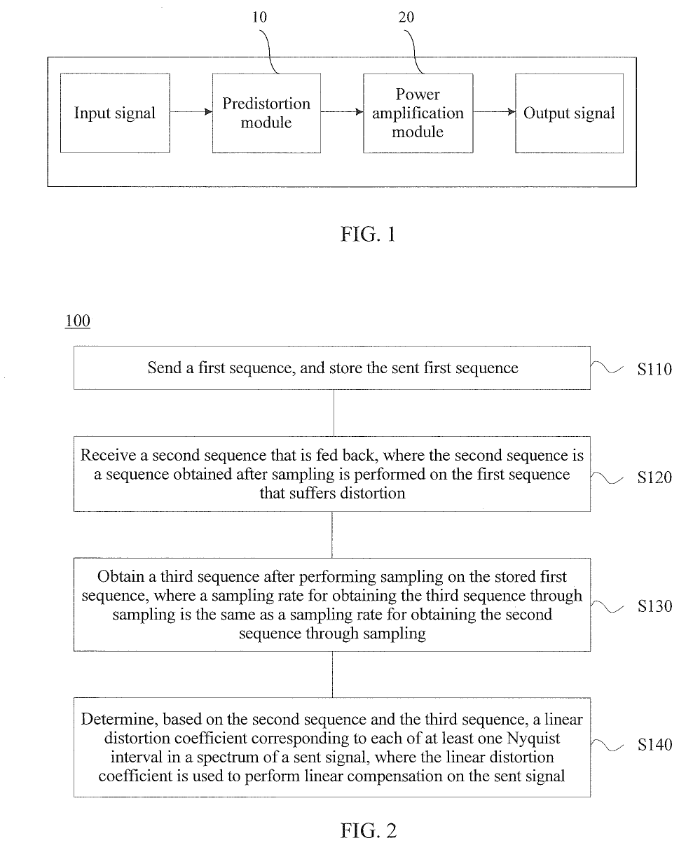

The embodiments of this application are applicable to various communications systems in which linear compensation and nonlinear compensation need to be performed on an input signal. FIG. 1 is a schematic diagram of an application scenario of a technical solution according to an embodiment of this application. As shown in FIG. 1, a predistortion module and a power amplification module can be combined to cancel linear and nonlinear characteristics of a power amplifier, thereby achieving compensation.

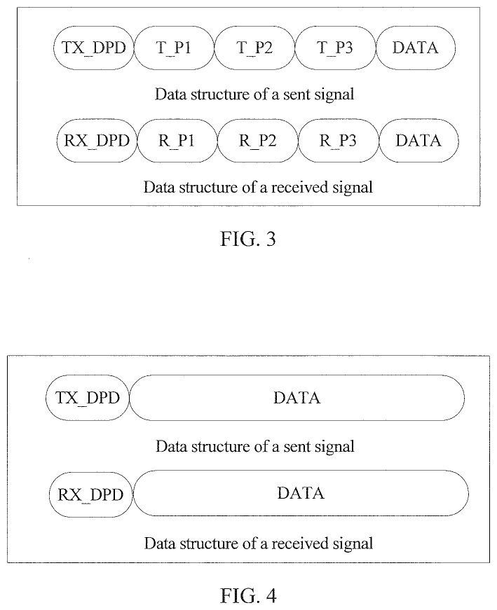

FIG. 2 is a schematic flowchart of a predistortion method 100 according to an embodiment of this application. As shown in FIG. 2, the method 100 includes the following steps.

S110. Send a first sequence, and store the sent first sequence.

S120. Receive a second sequence that is fed back, where the second sequence is a sequence obtained after sampling is performed on the first sequence that suffers distortion.

It should be understood that the predistortion method may be performed by a transmit end, or may be performed by a part of a transmit end, for example, may be performed by the predistortion module in FIG. 1.

Specifically, after sending the first sequence and storing the first sequence, the transmit end receives the second sequence that is fed back. The second sequence is a sequence obtained after sampling is performed on the first sequence that suffers distortion. The second sequence includes a linear distortion portion and a nonlinear distortion portion. The transmit end determines a linear distortion coefficient and a nonlinear distortion coefficient by using the second sequence that is fed back, and performs linear compensation on a sent signal of the transmit end, or performs linear compensation and then further performs nonlinear compensation on the sent signal. For example, in a down-sampling DPD technology, the predistortion module in the transmit end first sends the first sequence, the first sequence is processed by a digital-to-analog converter DAC, to obtain an analog signal, and the analog signal is processed by a power amplifier and then sent to a remote end (a receive end). To perform linear compensation and nonlinear compensation on the sent signal of the transmit end, feedback sampling needs to be performed on the analog signal that is output by the power amplifier. The second sequence is obtained after the analog signal is processed by a down-sampling analog-to-digital converter ADC in the transmit end. The analog-to-digital converter ADC feeds back the obtained second sequence to the predistortion module, and the second sequence includes linear distortion portion and nonlinear distortion portion.

It should be understood that a sampling rate for obtaining the second sequence through sampling depends on a hardware parameter of the transmit end or a hardware parameter of the predistortion module in the transmit end, and the transmit end or the predistortion module in the transmit end may learn of the hardware parameter in advance.

Optionally, the first sequence includes a first data sequence and a first preamble sequence set, and the second sequence includes a second data sequence corresponding to the first data sequence and a received sequence set corresponding to the first preamble sequence set.

For example, FIG. 3 is a schematic block diagram of a data structure of a sent signal and a data structure of a received signal according to an embodiment of this application. As shown in FIG. 3, the sent signal includes a first data sequence TX_DPD and a first preamble sequence set [T_P1, T_P2, T_P3]. A spectrum for sending a signal TX spans three Nyquist intervals: a first Nyquist interval, a second Nyquist interval, and a third Nyquist interval. As shown in the figure, three preamble sequences are separately designed. Spectrums of the three preamble sequences respectively occupy only the corresponding first Nyquist interval, second Nyquist interval, and third Nyquist interval. The first data sequence TX_DPD is selected as a normal data sequence for estimating a DPD coefficient. The transmit end receives the received signal that is fed back. The received signal includes a second sequence, and the second sequence includes a second data sequence RX_DPD and a received sequence set [R_P1, R_P2, R_P3].

It should be understood that, R_P1 includes linear distortion and nonlinear distortion in the first Nyquist interval, R_P2 includes linear distortion and nonlinear distortion in the second Nyquist interval, and R_P3 includes linear distortion and nonlinear distortion in the third Nyquist interval.

Optionally, the first sequence includes a first data sequence, and the second sequence includes a second data sequence corresponding to the first data sequence.

It should be understood that DATA in FIG. 3 represents normally transmitted data. Herein, because a location of TX_DPD is selected, the data structure shown in FIG. 3 exists. However, in practice, there is still normally output data prior to TX_DPD.

It should be further understood that, that a spectrum for sending a signal spans three Nyquist intervals is only one case, and the spectrum for sending a signal may alternatively span four or five Nyquist intervals, or may alternatively span another quantity of Nyquist intervals. This application is not limited thereto.

It should be further understood that, if the spectrum for sending a signal spans four Nyquist intervals, four preamble sequences may be separately designed. The four preamble sequences respectively occupy corresponding Nyquist intervals. This application is not limited thereto.

For example, FIG. 4 is another schematic block diagram of a data structure of a sent signal and a data structure of a received signal according to an embodiment of this application. As shown in FIG. 4, the sent signal includes a first data sequence TX_DPD. A spectrum for sending a signal spans three Nyquist intervals: a first Nyquist interval, a second Nyquist interval, and a third Nyquist interval. The first data sequence TX_DPD is selected as a normal data sequence for estimating a DPD coefficient. The transmit end extract data in each of the at least one Nyquist interval from the first data sequence TX_DPD, to obtain data in the first Nyquist interval, data in the second Nyquist interval, and data in the third Nyquist interval. The transmit end receives the received signal that is fed back. The received signal includes a second sequence, and the second sequence includes a second data sequence RX_DPD.

It should be understood that DATA in FIG. 4 represents normally transmitted data. Herein, because a location of TX_DPD is selected, the data structure shown in FIG. 4 exists. However, in practice, there is still normally output data prior to TX_DPD.

It should be further understood that a spectrum for sending a signal spans three Nyquist intervals is only one case, and the spectrum for sending a signal may alternatively span four or five Nyquist intervals, or may alternatively span another quantity of Nyquist intervals. This application is not limited thereto.

S130. Obtain a third sequence after performing sampling on the stored first sequence, where a sampling rate for obtaining the third sequence through sampling is the same as the sampling rate for obtaining the second sequence through sampling.

It should be understood that, if the transmit end obtains sampling rate information of the second sequence in advance, the transmit end obtains the third sequence by directly performing sampling on the stored first sequence. The sampling rate for obtaining the third sequence through sampling is the same as the sampling rate for obtaining the second sequence through sampling.

It should be further understood that there is no order between S120 of receiving a second sequence and S130 of obtaining a third sequence after performing sampling on the stored first sequence. The transmit end may obtain the sampling rate of the second sequence in advance, and perform sampling on the stored first sequence after sending the first sequence, to obtain the third sequence; or may receive the second sequence that is fed back, and then perform sampling on the stored first sequence, to obtain the third sequence.

For example, in the down-sampling DPD technology, the predistortion module obtains sampling rate information from the down-sampling analog-to-digital converter ADC in advance. The predistortion module performs sampling on the stored first sequence, to obtain the third sequence. The sampling rate for obtaining the third sequence through sampling is the same as the sampling rate at which the down-sampling analog-to-digital converter ADC obtains the second sequence through sampling.

Optionally, the first sequence includes the first data sequence and the first preamble sequence set. A spectrum of each preamble sequence in the first preamble sequence set corresponds to each of at least one Nyquist interval. The second sequence includes the second data sequence corresponding to the first data sequence and the received sequence set corresponding to the first preamble sequence set.

The obtaining a third sequence after performing sampling on the stored first sequence includes: obtaining a second preamble sequence set of the third sequence after performing sampling on the first preamble sequence set of the first sequence, where a sampling rate for obtaining the second preamble sequence set through sampling is the same as a sampling rate for obtaining the received sequence set through sampling.

Specifically, the transmit end obtains the second preamble sequence set of the third sequence after performing sampling on the first preamble sequence set of the stored first sequence, where the sampling rate for obtaining the second preamble sequence set through sampling is the same as the sampling rate for obtaining the received sequence set through sampling. The following describes a case in which a spectrum for sending a signal spans three Nyquist intervals, three preamble sequences T_P1, T_P2, and T_P3 are designed, a sampling rate of the first preamble sequence set is 3 GHz, and a sampling rate of the received sequence set is 1 GHz.

The transmit end obtains the second preamble sequence set of the third sequence after performing sampling on the first preamble sequence set of the stored first sequence, where the sampling rate for obtaining the second preamble sequence set through sampling is the same as the sampling rate for obtaining the received sequence set through sampling. Specifically, this may be implemented by using the following step.

The transmit end separately extracts data in T_P1, T_P2, and T_P3 at a rate of extracting one sampling point from every three sampling points, so that a data sampling rate after the extraction is changed from 3 GHz to 1 GHz, and a second preamble sequence set [T_P1_d, T_P2_d, T_P3_d] is obtained, where the second preamble sequence set has a same sampling rate as the received sequence set [R_P1, R_P2, and R_P3].

It should be understood that in the foregoing method, only the method of extracting one sampling point from every three sampling points is used to enable the sampling rate for obtaining the second preamble sequence set to be the same as the sampling rate for obtaining the received sequence set through sampling. Alternatively, other manners may be used to enable the sampling rate for obtaining the second preamble sequence set through sampling to be the same as the sampling rate for obtaining the received sequence set of the second sequence through sampling. Any manner in which the sampling rate of the first preamble sequence set can be changed to be the same as the sampling rate for obtaining the received sequence set through sampling falls within the protection scope of this application.

Optionally, the first sequence includes the first data sequence, and the second sequence includes the second data sequence corresponding to the first data sequence.

The obtaining a third sequence after performing sampling on the stored first sequence includes:

extracting data in each of at least one Nyquist interval from the first data sequence; and

obtaining a reference sequence set after performing sampling on the data in each of the at least one Nyquist interval, where a sampling rate for obtaining the reference sequence set through sampling is the same as a sampling rate for obtaining the second data sequence through sampling.

Specifically, the transmit end first extracts the data in each Nyquist interval from the first data sequence, and obtains the reference sequence set after performing sampling on the data in each Nyquist interval, where the sampling rate for obtaining the reference sequence set through sampling is the same as the sampling rate for obtaining the second data sequence of the second sequence through sampling. The following describes a case in which a spectrum for sending a signal spans three Nyquist intervals, a sampling rate of the data in each of the at least one Nyquist interval is 3 GHz, and the sampling rate of the second data sequence is 1 GHz.

The transmit end obtains the reference sequence set after performing sampling on the data in each of the at least one Nyquist interval, where the sampling rate for obtaining the reference sequence set through sampling is the same as the sampling rate for obtaining the second data sequence through sampling. Specifically, this may be implemented by using the following step.

The transmit end extracts data in a first Nyquist interval from TX_DPD by using a digital band-pass filter, and performs sampling (triple sampling) on the data in the first Nyquist interval, to obtain data having a same sampling rate as RX_DPD.

It should be understood that in the foregoing method, only the method of triple sampling is used to change a sampling rate of the first data sequence. Alternatively, other manners may be used to change a sampling rate of the first data sequence, so that the sampling rate is the same as the sampling rate of the second data sequence. Any manner in which the sampling rate of the first data sequence can be changed to be the same as the sampling rate of the second data sequence falls within the protection scope of this application.

S140. Determine, based on the second sequence and the third sequence, a linear distortion coefficient corresponding to each of the at least one Nyquist interval in the spectrum for sending a signal, where the linear distortion coefficient is used to perform linear compensation on the sent signal.

Optionally, if the first sequence includes the first data sequence and the first preamble sequence set, and the second sequence includes the second data sequence corresponding to the first data sequence and the received sequence set corresponding to the first preamble sequence set, that the transmit end determines, based on the second sequence and the third sequence, a linear distortion coefficient corresponding to each of the at least one Nyquist interval in the spectrum for sending a signal includes the following:

The transmit end determines, based on the received sequence set and the second preamble sequence set, the linear distortion coefficient corresponding to each of the at least one Nyquist interval in the spectrum for sending a signal.

It should be understood that, the foregoing step of determining, by using T_P1_d and R_P1, a linear distortion coefficient corresponding to the first Nyquist interval may be implemented by using an LS method. This application is not limited thereto.

According to the predistortion method in this embodiment of this application, due to design of preamble sequences, the linear distortion coefficient corresponding to each Nyquist interval in the spectrum for sending a signal can be accurately estimated, so that linear compensation is effectively performed on data in each Nyquist interval in the spectrum for sending a signal.

Optionally, if the first sequence includes the first data sequence, that the transmit end determines, based on the second sequence and the third sequence, a linear distortion coefficient corresponding to each of the at least one Nyquist interval in the spectrum for sending a signal includes the following:

The transmit end determines, based on the second data sequence and the reference sequence set, the linear distortion coefficient corresponding to each of the at least one Nyquist interval in the spectrum for sending a signal.

It should be understood that the foregoing step of determining, by using the data in the first Nyquist interval and RX_DPD, a linear distortion coefficient corresponding to the first Nyquist interval may be implemented by using an LS method. This application is not limited thereto.

According to the predistortion method in this embodiment of this application, the linear distortion coefficient corresponding to each Nyquist interval in the spectrum for sending a signal can be estimated, so that linear compensation can be performed on the data in each Nyquist interval in the spectrum for sending a signal.

Optionally, if the first sequence includes the first preamble sequence set and the first data sequence, the method further includes:

extracting data in each of the at least one Nyquist interval from the first data sequence; and

obtaining a reference sequence set after performing sampling on the data in each of the at least one Nyquist interval, where a sampling rate for obtaining the reference sequence set through sampling is the same as a sampling rate for obtaining the second data sequence through sampling.

That the linear distortion coefficient is used to perform linear compensation on the sent signal includes: performing linear compensation on the reference sequence set.

Optionally, if the first sequence includes the first data sequence, the reference sequence set is compensated for by directly using the estimated linear distortion coefficient corresponding to each Nyquist interval.

Optionally, the predistortion method further includes: determining a first reference data set based on the reference sequence set and the linear distortion coefficient that is corresponding to each of the at least one Nyquist interval, where the first reference data set is used to determine a nonlinear distortion coefficient of the sent signal.

It should be understood that, the determining a first reference data set based on the reference sequence set and the linear distortion coefficient that is corresponding to each of the at least one Nyquist interval includes: obtaining the first reference data set by performing convolution on the reference sequence set and the linear distortion coefficient that is corresponding to each of the at least one Nyquist interval. This application is not limited thereto.

Optionally, the method further includes:

determining the nonlinear distortion coefficient of the sent signal based on the first reference data set and the second data sequence; and

performing nonlinear compensation on the sent signal based on the nonlinear distortion coefficient.

Optionally, the determining the nonlinear distortion coefficient of the sent signal based on the first reference data set and the second data sequence includes:

adding all reference data in the first reference data set, to obtain second reference data; and

determine the nonlinear distortion coefficient of the sent signal based on the second reference data and the second data sequence.

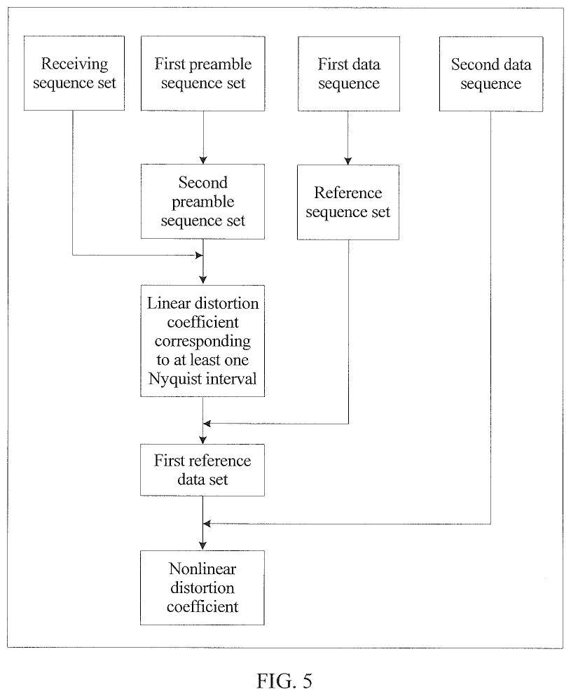

FIG. 5 is an algorithm flowchart of a predistortion method according to an embodiment of this application. As shown in FIG. 5, after a transmit end obtains a second preamble sequence set [T_P1_d, T_P2_d, T_P3_d] by using a first preamble sequence set [T_P1, T_P2, T_P3], the transmit end determines, based on the second preamble sequence set [T_P1_d, T_P2_d, T_P3_d] and a received sequence set [R_P1, R_P2, R_P3], a linear distortion coefficient corresponding to each of at least one Nyquist interval in a spectrum of a sent signal. A linear distortion coefficient Fir1 corresponding to a first Nyquist interval is determined by using T_P1_d and R_P1, a linear distortion coefficient Fir2 corresponding to a second Nyquist interval is determined by using T_P2_d and R_P2, and a linear distortion coefficient Fir3 corresponding to a third Nyquist interval is determined by using T_P3_d and R_P3. After estimating the linear distortion coefficient corresponding to each of the at least one Nyquist interval, the transmit end further needs to extract data in each of the at least one Nyquist interval from a first data sequence, and obtain a reference sequence set after performing sampling on the data in each Nyquist interval. The transmit end compensates for the reference sequence set by using the estimated linear distortion coefficients Fir1, Fir2, and Fir3 corresponding to the Nyquist intervals. The transmit end determines a first reference data set Ref_DPD based on the reference sequence set and the linear distortion coefficient that is corresponding to each of the at least one Nyquist interval. The transmit end determines a nonlinear distortion coefficient of the sent signal based on the first reference data set Ref_DPD and a second data sequence RX_DPD. The transmit end performs nonlinear compensation on the sent signal based on the nonlinear distortion coefficient.

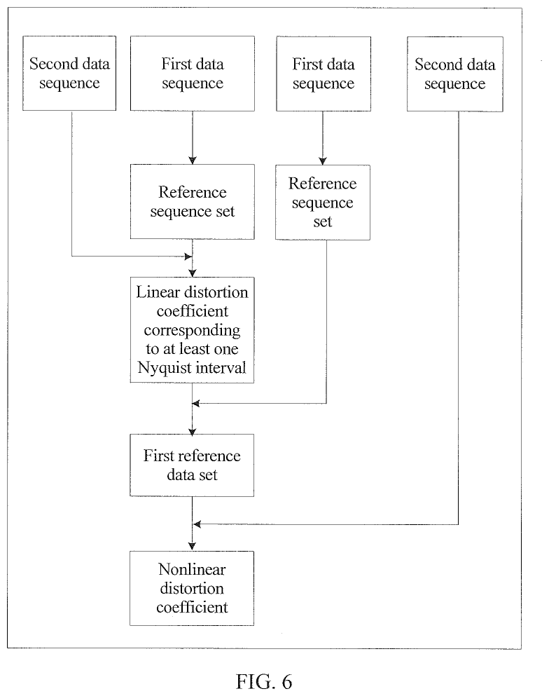

FIG. 6 is another algorithm flowchart of a predistortion method according to an embodiment of this application. As shown in FIG. 6, a transmit end extracts data in each of at least one Nyquist interval from a first data sequence TX_DPD, and obtains a reference sequence set after performing sampling on the data in each Nyquist interval. The transmit end determines, based on the reference sequence set and a second data sequence RX_DPD, a linear distortion coefficient corresponding to each of the at least one Nyquist interval in a spectrum of a sent signal. A linear distortion coefficient Fir1 corresponding to a first Nyquist interval is determined based on RX_DPD and data that is obtained after sampling is performed on data in the first Nyquist interval, a linear distortion coefficient Fir2 corresponding to a second Nyquist interval is determined based on RX_DPD and data that is obtained after sampling is performed on data in the second Nyquist interval, and a linear distortion coefficient Fir3 corresponding to a third Nyquist interval is determined based on RX_DPD and data that is obtained after sampling is performed on data in the third Nyquist interval. After the transmit end estimates the linear distortion coefficient corresponding to each of the at least one Nyquist interval, the transmit end compensates for the reference sequence set by using the estimated linear distortion coefficients Fir1, Fir2, and Fir3 corresponding to the Nyquist intervals. The transmit end determines a first reference data set Ref_DPD based on the reference sequence set and the linear distortion coefficient that is corresponding to each of the at least one Nyquist interval. The transmit end determines a nonlinear distortion coefficient of the sent signal based on the first reference data set Ref_DPD and the second data sequence RX_DPD. The transmit end performs nonlinear compensation on the sent signal based on the nonlinear distortion coefficient.

According to the predistortion method in this embodiment of this application, linear distortion of each of the at least one Nyquist interval in the spectrum for sending a signal can be effectively estimated and compensated for, so that nonlinear distortion of the sent signal can be effectively estimated and compensated for.

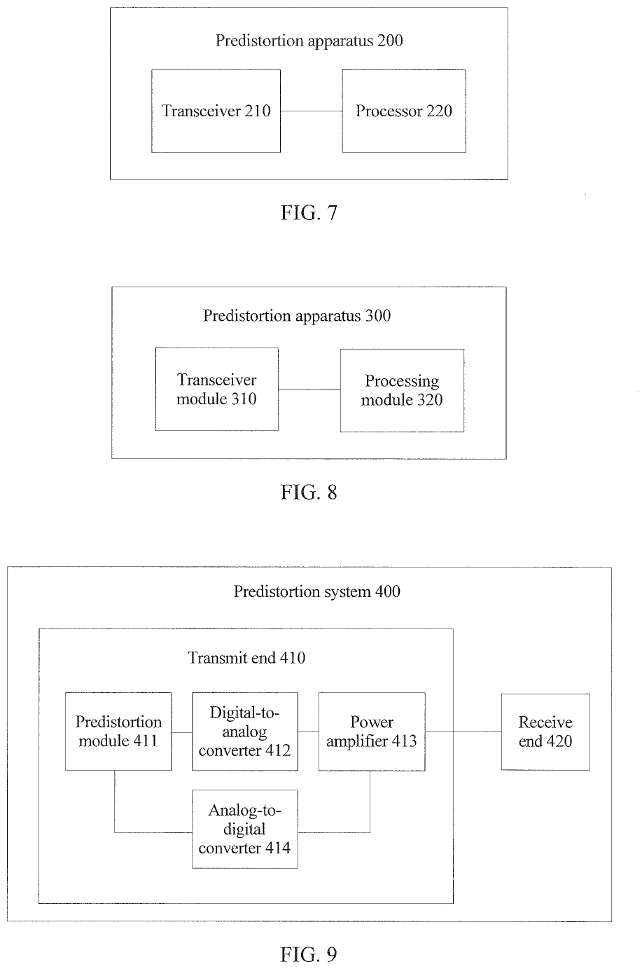

The foregoing describes in detail the predistortion method according to the embodiments of this application with reference to FIG. 2 to FIG. 6. The following describes in detail a predistortion apparatus and system in the embodiments of this application with reference to FIG. 7 to FIG. 10.

FIG. 7 is a schematic block diagram of a predistortion apparatus 200 according to an embodiment of this application. As shown in FIG. 7, the apparatus 200 includes:

a transceiver 210, configured to: send a first sequence, and store the sent first sequence, where

the transceiver 210 is further configured to receive a second sequence that is fed back, where the second sequence is a sequence obtained after sampling is performed on the first sequence that suffers distortion; and

a processor 220, configured to obtain a third sequence after performing sampling on the stored first sequence, where a sampling rate for obtaining the third sequence through sampling is the same as a sampling rate for obtaining the second sequence through sampling, where

the processor 220 is further configured to determine, based on the second sequence and the third sequence, a linear distortion coefficient corresponding to each of at least one Nyquist interval in a spectrum for sending a signal, where

the linear distortion coefficient is used to perform linear compensation on the sent signal.

It should be understood that the predistortion apparatus 200 may correspond to the predistortion module in FIG. 1, or may correspond to a part or an entirety of a transmit end in a DPD technology. A transceiver 210 in the transmit end sends a first sequence, and stores the sent first sequence; and receives a second sequence that is fed back, where the second sequence is a sequence obtained after sampling is performed on the first sequence that suffers distortion. A processor 220 in the transmit end obtains a third sequence after performing sampling on the stored first sequence, where a sampling rate for obtaining the third sequence through sampling is the same as a sampling rate for obtaining the second sequence through sampling. The processor 220 in the transmit end calculates a linear distortion coefficient corresponding to each of at least one Nyquist interval based on the second sequence and the third sequence, and the processor 220 in the transmit end performs linear compensation and nonlinear compensation on a sent signal, thereby achieving compensation.

According to the predistortion apparatus in this embodiment of this application, linear distortion can be effectively estimated and compensated for, to help avoid affecting subsequent nonlinear distortion estimation and compensation.

Optionally, the first sequence includes a first data sequence and a first preamble sequence set, a spectrum of one preamble sequence in the first preamble sequence set corresponds to one Nyquist interval, and the second sequence includes a second data sequence corresponding to the first data sequence and a received sequence set corresponding to the first preamble sequence set.

The processor 220 is specifically configured to obtain a second preamble sequence set of the third sequence after performing sampling on the first preamble sequence set of the first sequence, where a sampling rate for obtaining the second preamble sequence set through sampling is the same as a sampling rate for obtaining the received sequence set through sampling.

The processor 220 is further configured to determine, based on the received sequence set and the second preamble sequence set, the linear distortion coefficient corresponding to each of the at least one Nyquist interval in the spectrum for sending a signal.

According to the predistortion apparatus in this embodiment of this application, due to design of preamble sequences, the linear distortion coefficient corresponding to each Nyquist interval in the spectrum for sending a signal can be accurately estimated, so that linear compensation is effectively performed on data in each Nyquist interval in the spectrum for sending a signal.

Optionally, the first sequence includes a first data sequence, and the second sequence includes a second data sequence corresponding to the first data sequence.

The processor 220 is specifically configured to: extract data in each of the at least one Nyquist interval from the first data sequence; and

obtain a reference sequence set after performing sampling on the data in each of the at least one Nyquist interval, where a sampling rate for obtaining the reference sequence set through sampling is the same as a sampling rate for obtaining the second data sequence through sampling.

The processor 220 is further configured to determine, based on the second data sequence and the reference sequence set, the linear distortion coefficient corresponding to each of the at least one Nyquist interval in the spectrum for sending a signal.

According to the predistortion apparatus in this embodiment of this application, the linear distortion coefficient corresponding to each Nyquist interval in the spectrum for sending a signal can be estimated, so that linear compensation can be performed on data in each Nyquist interval of a data sequence.

Optionally, the processor 220 is specifically configured to perform linear compensation on the reference sequence set.

Optionally, the processor 220 is further configured to: extract data in each of the at least one Nyquist interval from the first data sequence; and

obtain a reference sequence set after performing sampling on the data in each of the at least one Nyquist interval, where a sampling rate for obtaining the reference sequence set through sampling is the same as a sampling rate for obtaining the second data sequence through sampling.

The processor 220 is specifically configured to perform linear compensation on the reference sequence set.

Optionally, the processor 220 is further configured to determine a first reference data set based on the reference sequence set and the linear distortion coefficient that is corresponding to each of the at least one Nyquist interval, where the first reference data set is used to determine a nonlinear distortion coefficient of the sent signal.

Optionally, the processor 220 is further configured to determine the nonlinear distortion coefficient of the sent signal based on the first reference data set and the second data sequence.

The processor 220 is further configured to perform nonlinear compensation on the sent signal based on the nonlinear distortion coefficient.

Optionally, the processor 220 is specifically configured to: add all reference data in the first reference data set, to obtain second reference data; and determine the nonlinear distortion coefficient of the sent signal based on the second reference data and the second data sequence.

According to the predistortion apparatus in this embodiment of this application, linear distortion of each of the at least one Nyquist interval in the spectrum for sending a signal can be effectively estimated and compensated for, so that nonlinear distortion of the sent signal can be effectively estimated and compensated for.

FIG. 8 is a schematic block diagram of a predistortion apparatus 300 according to an embodiment of this application. As shown in FIG. 8, the apparatus 300 includes:

a transceiver module 310, configured to: send a first sequence, and store the sent first sequence, where

the transceiver module 310 is further configured to receive a second sequence that is fed back, where the second sequence is a sequence obtained after sampling is performed on the first sequence that suffers distortion; and

a processing module 320, configured to obtain a third sequence after performing sampling on the stored first sequence, where a sampling rate for obtaining the third sequence through sampling is the same as a sampling rate for obtaining the second sequence through sampling, where

the processing module 320 is further configured to determine, based on the second sequence and the third sequence, a linear distortion coefficient corresponding to each of at least one Nyquist interval in a spectrum for sending a signal, where

the linear distortion coefficient is used to perform linear compensation on the sent signal.

It should be understood that the predistortion apparatus 300 may correspond to the predistortion module in FIG. 1, or may correspond to a part or an entirety of a transmit end in a DPD technology. A transceiver module 310 in the transmit end sends a first sequence, and stores the sent first sequence; and receives a second sequence that is fed back, where the second sequence is a sequence obtained after sampling is performed on the first sequence that suffers distortion. A processing module 320 in the transmit end obtains a third sequence after performing sampling on the stored first sequence, where a sampling rate for obtaining the third sequence through sampling is the same as a sampling rate for obtaining the second sequence through sampling. The processing module 320 in the transmit end calculates a linear distortion coefficient corresponding to each of at least one Nyquist interval based on the second sequence and the third sequence, and the processor in the transmit end performs linear compensation and nonlinear compensation on a sent signal, thereby achieving compensation.

According to the predistortion apparatus in this embodiment of this application, linear distortion can be effectively estimated and compensated for, to help avoid affecting subsequent nonlinear distortion estimation and compensation.

Optionally, the first sequence includes a first data sequence and a first preamble sequence set, a spectrum of one preamble sequence in the first preamble sequence set corresponds to one Nyquist interval, and the second sequence includes a second data sequence corresponding to the first data sequence and a received sequence set corresponding to the first preamble sequence set.

The processing module 320 is specifically configured to obtain a second preamble sequence set of the third sequence after performing sampling on the first preamble sequence set of the first sequence, where a sampling rate for obtaining the second preamble sequence set through sampling is the same as a sampling rate for obtaining the received sequence set through sampling.

The processing module 320 is further configured to determine, based on the received sequence set and the second preamble sequence set, the linear distortion coefficient corresponding to each of the at least one Nyquist interval in the spectrum for sending a signal.

According to the predistortion apparatus in this embodiment of this application, due to design of preamble sequences, the linear distortion coefficient corresponding to each Nyquist interval in the spectrum for sending a signal can be accurately estimated, so that linear compensation is effectively performed on data in each Nyquist interval of a data sequence.

Optionally, the first sequence includes a first data sequence, and the second sequence includes a second data sequence corresponding to the first data sequence.

The processing module 320 is specifically configured to: extract data in each of the at least one Nyquist interval from the first data sequence; and

obtain a reference sequence set after performing sampling on the data in each of the at least one Nyquist interval, where a sampling rate for obtaining the reference sequence set through sampling is the same as a sampling rate for obtaining the second data sequence through sampling.

The processing module 320 is further configured to determine, based on the second data sequence and the reference sequence set, the linear distortion coefficient corresponding to each of the at least one Nyquist interval in the spectrum for sending a signal.

According to the predistortion apparatus in this embodiment of this application, the linear distortion coefficient corresponding to each Nyquist interval in the spectrum for sending a signal can be estimated, so that linear compensation can be performed on data in each Nyquist interval of a data sequence.

Optionally, the processing module 320 is specifically configured to perform linear compensation on the reference sequence set.

Optionally, the processing module 320 is further configured to: extract data in each of the at least one Nyquist interval from the first data sequence; and

obtain a reference sequence set after performing sampling on the data in each of the at least one Nyquist interval, where a sampling rate for obtaining the reference sequence set through sampling is the same as a sampling rate for obtaining the second data sequence through sampling.

The processing module 320 is specifically configured to perform linear compensation on the reference sequence set.

Optionally, the processing module 320 is further configured to determine a first reference data set based on the reference sequence set and the linear distortion coefficient that is corresponding to each of the at least one Nyquist interval, where the first reference data set is used to determine a nonlinear distortion coefficient of the sent signal.

Optionally, the processing module 320 is further configured to determine the nonlinear distortion coefficient of the sent signal based on the first reference data set and the second data sequence.

The processing module 320 is further configured to perform nonlinear compensation on the sent signal based on the nonlinear distortion coefficient.

Optionally, the processing module 320 is specifically configured to: add all reference data in the first reference data set, to obtain second reference data; and

determine the nonlinear distortion coefficient of the sent signal based on the second reference data and the second data sequence.

According to the predistortion apparatus in this embodiment of this application, linear distortion of each of the at least one Nyquist interval in the spectrum for sending a signal can be effectively estimated and compensated for, so that nonlinear distortion of the sent signal can be effectively estimated and compensated for.

FIG. 9 is a schematic block diagram of a predistortion system 400 according to an embodiment of this application. As shown in FIG. 9, the predistortion system 400 includes a transmit end 410 and a receive end 420. The transmit end 410 includes a predistortion module 411, a digital-to-analog converter 412, a power amplifier 413, and an analog-to-digital converter 414. The predistortion module 411 sends a first sequence, and stores the sent first sequence. An analog signal is obtained after the first sequence is processed by the digital-to-analog converter 412, and the analog signal is processed by the power amplifier 413 and then sent to the receive end 420. The analog signal suffers linear distortion and nonlinear distortion after the analog signal is processed by the power amplifier 413. In addition, the analog signal may be further processed by a coupler after the analog signal is processed by the power amplifier 413. A second sequence is obtained after the amplified analog signal is processed by the analog-to-digital converter 414, where the second sequence includes linear distortion portion and nonlinear distortion portion. The analog-to-digital converter 414 sends the output second sequence to the predistortion module 411. The predistortion module 411 obtains a third sequence after performing sampling on the stored first sequence, where a sampling rate for obtaining the third sequence through sampling is the same as a sampling rate for obtaining the second sequence through sampling. The predistortion module 411 determines, based on the second sequence and the third sequence, a linear distortion coefficient corresponding to each of at least one Nyquist interval in a spectrum for sending a signal, and performs linear compensation and nonlinear compensation on the sent signal based on the linear distortion coefficient.

It should be understood that the predistortion module 411 may be configured to perform the method 100, and may correspond to the apparatus 200, that is, may include the transceiver 210 and the processor 220 in the apparatus 200, or may correspond to the apparatus 300, that is, may include the transceiver module 310 and the processing module 320 in the apparatus 300.

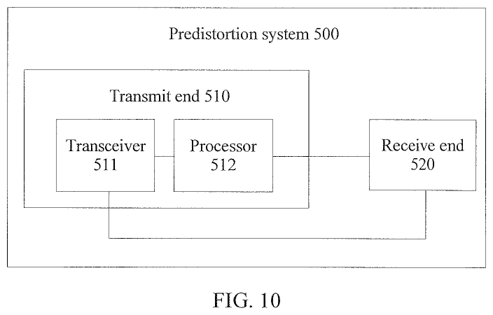

FIG. 10 is a schematic block diagram of a predistortion system 500 according to an embodiment of this application. As shown in FIG. 10, a transmit end 510 may correspond to the apparatus 200 or the apparatus 300, or may correspond to the predistortion module 411 in the system 400. A transceiver 511 may correspond to the transceiver 210 in the apparatus 200, or may correspond to the transceiver module 310 in the apparatus 300. A processor 512 may correspond to the processor 220 in the apparatus 200, or may correspond to the processing module 320 in the apparatus 300. A receive end 520 receives a signal and provides a feedback to the transmit end.

The processor in the embodiments of this application may be a central processing unit (Central Processing Unit, CPU), a network processor (Network Processor, NP), or a combination of a CPU and an NP. The processor may further include a hardware chip. The hardware chip may be an application-specific integrated circuit (Application-Specific Integrated Circuit, ASIC), a programmable logic device (Programmable Logic Device, PLD), or a combination thereof. The PLD may be a complex programmable logic device (Complex Programmable Logic Device, CPLD), a field programmable gate array (Field Programmable Gate Array, FPGA), generic array logic (Generic Array Logic, GAL), or any combination thereof.

A memory may be a volatile memory or a nonvolatile memory, or may include a volatile memory and a nonvolatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache.

The foregoing embodiments may be all or partially implemented by software, hardware, firmware, or any combination thereof. When software is used to implement the embodiments, the embodiments may be all or partially implemented in a form of a computer program product. The computer program product may include one or more computer instructions. When the computer program instructions are loaded and executed on a computer, the processes or functions according to the embodiments of this application are all or partially generated. The computer may be a general-purpose computer, a dedicated computer, a computer network, or other programmable apparatuses. The computer instructions may be stored in a computer readable storage medium, or may be transmitted from a computer readable storage medium to another computer readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic disk), an optical medium (for example, a DVD), a semiconductor medium (for example, a solid state disk Solid State Disk (SSD)), or the like.

A person of ordinary skill in the art may be aware that, units and algorithm steps in the examples described with reference to the embodiments disclosed in this specification may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, function units in the embodiments of this application may be integrated into one processing unit, or each of the units may exist alone physically, or two or more units may be integrated into one unit.

When the functions are implemented in a form of a software function unit and sold or used as an independent product, the functions may be stored in a computer readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of this application. The foregoing storage medium includes: any medium that can store program code, such as a USB flash drive, a removable hard disk, a read-only memory, a random access memory, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A predistortion method, comprising:
sending a first sequence, and storing the sent first sequence;
receiving a second sequence that is fed back, wherein the second sequence is a sequence obtained after sampling is performed on the first sequence that suffers distortion;
obtaining a third sequence after performing sampling on the stored first sequence, wherein a sampling rate for obtaining the third sequence through sampling is the same as a sampling rate for obtaining the second sequence through sampling; and
determining, based on the second sequence and the third sequence, a linear distortion coefficient corresponding to each of at least one Nyquist interval in a spectrum for sending a signal,
wherein the linear distortion coefficient is used to perform linear compensation on the sent signal.

2. The method according to claim 1, wherein the first sequence comprises a first data sequence and a first preamble sequence set, a spectrum of one preamble sequence in the first preamble sequence set corresponds to one Nyquist interval, and the second sequence comprises a second data sequence corresponding to the first data sequence and a received sequence set corresponding to the first preamble sequence set;
the obtaining the third sequence after performing sampling on the stored first sequence comprises:
obtaining a second preamble sequence set of the third sequence after performing sampling on the first preamble sequence set of the first sequence, wherein a sampling rate for obtaining the second preamble sequence set through sampling is the same as a sampling rate for obtaining the received sequence set through sampling; and
the determining, based on the second sequence and the third sequence, the linear distortion coefficient corresponding to each of the at least one Nyquist interval in the spectrum for sending the signal comprises:
determining, based on the received sequence set and the second preamble sequence set, the linear distortion coefficient corresponding to each of the at least one Nyquist interval in the spectrum for sending the signal.

3. The method according to claim 1, wherein the first sequence comprises a first data sequence, and the second sequence comprises a second data sequence corresponding to the first data sequence;
the obtaining the third sequence after performing sampling on the stored first sequence comprises:
extracting data in each of the at least one Nyquist interval from the first data sequence; and
obtaining a reference sequence set after performing sampling on the data in each of the at least one Nyquist interval, wherein a sampling rate for obtaining the reference sequence set through sampling is the same as a sampling rate for obtaining the second data sequence through sampling; and
the determining, based on the second sequence and the third sequence, a linear distortion coefficient corresponding to each of the at least one Nyquist interval in the spectrum for sending the signal comprises:
determining, based on the second data sequence and the reference sequence set, the linear distortion coefficient corresponding to each of the at least one Nyquist interval in the spectrum for sending the signal.

4. The method according to claim 3, wherein that the linear distortion coefficient is used to perform linear compensation on the sent signal comprises: performing linear compensation on the reference sequence set.

5. The method according to claim 2, wherein the method further comprises:
extracting data in each of the at least one Nyquist interval from the first data sequence; and
obtaining a reference sequence set after performing sampling on the data in each of the at least one Nyquist interval, wherein a sampling rate for obtaining the reference sequence set through sampling is the same as a sampling rate for obtaining the second data sequence through sampling, wherein
that the linear distortion coefficient is used to perform linear compensation on the sent signal comprises: performing linear compensation on the reference sequence set.

6. The method according to claim 3, wherein the method further comprises:
determining a first reference data set based on the reference sequence set and the linear distortion coefficient that is corresponding to each of the at least one Nyquist interval, wherein the first reference data set is used to determine a nonlinear distortion coefficient of the sent signal.

7. The method according to claim 6, wherein the method further comprises:
determining the nonlinear distortion coefficient of the sent signal based on the first reference data set and the second data sequence; and
performing nonlinear compensation on the sent signal based on the nonlinear distortion coefficient.

8. The method according to claim 7, wherein the determining the nonlinear distortion coefficient of the sent signal based on the first reference data set and the second data sequence comprises:
adding all reference data in the first reference data set, to obtain second reference data; and
determining the nonlinear distortion coefficient of the sent signal based on the second reference data and the second data sequence.

9. A predistortion apparatus, comprising:
a transceiver, configured to:
send a first sequence, and store the sent first sequence, and
receive a second sequence that is fed back, wherein the second sequence is a sequence obtained after sampling is performed on the first sequence that suffers distortion; and
a processor, configured to:
obtain a third sequence after performing sampling on the stored first sequence, wherein a sampling rate for obtaining the third sequence through sampling is the same as a sampling rate for obtaining the second sequence through sampling, and
determine, based on the second sequence and the third sequence, a linear distortion coefficient corresponding to each of at least one Nyquist interval in a spectrum for sending a signal, wherein
the linear distortion coefficient is used to perform linear compensation on the sent signal.

10. The apparatus according to claim 9, wherein the first sequence comprises a first data sequence and a first preamble sequence set, a spectrum of one preamble sequence in the first preamble sequence set corresponds to one Nyquist interval, and the second sequence comprises a second data sequence corresponding to the first data sequence and a received sequence set corresponding to the first preamble sequence set;
the processor is further configured to obtain a second preamble sequence set of the third sequence after performing sampling on the first preamble sequence set of the first sequence, wherein a sampling rate for obtaining the second preamble sequence set through sampling is the same as a sampling rate for obtaining the received sequence set through sampling; and
the processor is further configured
to determine, based on the received sequence set and the second preamble sequence set, the linear distortion coefficient corresponding to each of the at least one Nyquist interval in the spectrum for sending the signal.

11. The apparatus according to claim 9, wherein the first sequence comprises a first data sequence, and the second sequence comprises a second data sequence corresponding to the first data sequence;
the processor is further configured to:
extract data in each of the at least one Nyquist interval from the first data sequence; and obtain a reference sequence set after performing sampling on the data in each of the at least one Nyquist interval, wherein a sampling rate for obtaining the reference sequence set through sampling is the same as a sampling rate for obtaining the second data sequence through sampling; and
determine, based on the second data sequence and the reference sequence set, the linear distortion coefficient corresponding to each of the at least one Nyquist interval in the spectrum for sending the signal.

12. The apparatus according to claim 11, wherein the processor is further configured to perform linear compensation on the reference sequence set.

13. The apparatus according to claim 10, wherein the processor is further configured to:
extract data in each of the at least one Nyquist interval from the first data sequence; and obtain a reference sequence set by performing sampling on the data in each of the at least one Nyquist interval, wherein a sampling rate for obtaining the reference sequence set through sampling is the same as a sampling rate for obtaining the second data sequence through sampling; and
perform linear compensation on the reference sequence set.

14. The apparatus according to claim 11, wherein the processor is further configured to determine a first reference data set based on the reference sequence set and the linear distortion coefficient that is corresponding to each of the at least one Nyquist interval, wherein the first reference data set is used to determine a nonlinear distortion coefficient of the sent signal.

15. The apparatus according to claim 14, wherein the processor is further configured to:
determine the nonlinear distortion coefficient of the sent signal based on the first reference data set and the second data sequence; and
perform nonlinear compensation on the sent signal based on the nonlinear distortion coefficient.

16. The apparatus according to claim 15, wherein the processor is further configured to:
add all reference data in the first reference data set, to obtain second reference data; and
determine the nonlinear distortion coefficient of the sent signal based on the second reference data and the second data sequence.

17. A predistortion system, comprising a transmit end and a receive end, wherein the transmit end comprises the apparatus according to claim 9.
